(19) United States
(12) Patent Application Publication
(10) Pub. No.: US 2014/0358512 A1
(43) Pub. Date: Dec. 4, 2014

(54) AUTOMATED CONSTRUCTION OF ION-CHANNEL MODELS IN A MULTI-COMPARMENT MODELS

(71) Applicant: International Business Machines Corporation, Armonk, NY (US)

(72) Inventors: David I. KAPLAN, North Caulfield (AU); James R. KOZLOSKI, New Fairfield, CT (US); Charles Clyde PECK, III, Newtown, CT (US); John WAGNER, North Melbourne (AU)

(21) Appl. No.: 13/908,670

(22) Filed: Jun. 3, 2013

(51) Int. Cl. G06F 19/12

(52) U.S. Cl. CPC G06F 19/12
USPC 703/11

(57) ABSTRACT

Disclosed is a novel system and method to develop computational models of membrane conductances through training a multi-layer perceptron to predict a channel's responses (conductances) to different conditions (voltage histories). Initially, at each time step of the dAPC protocol the current generated across the TCL1 cell membrane is determined by the history of voltages calculated in the model compartment. These data collected from dAPC are then used to train a perceptron, whose inputs are select time points in this history, and whose output predicts the channel conductances measured by the dAPC apparatus. The trained perceptron then becomes a model of the channel, comprising a specific set of historical voltage data points from compartment models provided as inputs to a specific combination of hidden units to produce an output that predicts channel conductance given a particular voltage history.

### BACKGROUND

The present invention generally relates to ion-channel conductance, and more specifically to building computational models of ion-channel conductance.

In many living organisms signals are transmitted between cells, such as neurons and muscle cells, by variations across cell membranes in electrophysiological parameters such as voltage, current or capacitance. Variations in such electrophysiological parameters often involve large numbers of multiple types of ion channels or receptors, which together produce a waveform at the biological cell. An action potential is an example of one type of waveform.

The waveform results from modulation of ion channels or receptors at the cell. For example, these ion channels or receptors may regulate the transmembrane and intercellular movement of physiological ions, such as Na⁺, K⁺, Ca²⁺, and Cl⁻, which form part of the signal. Modulation of one, or a group of ion channels or receptors results in electrophysiological changes at the membrane of the cell, causing further ion channels to be modulated. This process is closely coupled by feedback. Therefore the waveform produced at the biological cell varies depending on parameters such as the ion channels or receptors which are modulated and the length of time that those ion channels or receptors are activated or inhibited.

Compounds that affect waveforms produced at biological cells may be useful in treating or ameliorating a range of diseases and disorders. For example, action potentials control the function of nerve and muscle tissue, and accordingly influence many physiological functions including the capacity of a body to influence pathology. Similarly, other waveforms such as synaptic events are involved in many nervous system processes. Compounds that affect the production of waveforms at biological cells may therefore be useful in the treatment or amelioration of, for example, a range of neuromuscular, cardiac, pain, affective and cognitive disorders.

However, the effect of any particular compound on a waveform is difficult to assess. As the production of a waveform in a cell involves individual contributions from multiple ion-channel or receptor types, the duration of each waveform, the peak membrane potential and many other parameters may vary. Therefore, all necessary ion-channel or receptor types to produce a waveform must be present and functional in order to properly observe the effects of the compound on the biological cell. This is usually performed by observing effects of compounds in intact samples of biological tissue, such as recording action potentials in nerve fibres in a living animal model or recording cardiac action potentials by isolation of a purkinje fibre from a dog heart. The requirement for biological tissue limits the number of compounds that can be assessed in a given period of time.

Current methods for building computational models of ion-channel conductances demand extensive electrophysiological assays to generate data needed to fit characteristic equations that approximate channel kinetics. These equations are designed by domain experts, and refined and validated over many weeks or months of experiments on the ion-channel. Automation in this domain has focused on faster access to the measurements, with little focus on faster methods for model building. Furthermore, even when characteristic equations for a channel are formally expressed in this way, the presence of novel compounds in proximity to the ion-channel (e.g., drugs) can alter the kinetics sufficiently that the original equations must be modified by further experimentation and measurements.

### BRIEF SUMMARY

Disclosed is an automated system and method the inventors call “delay Simulation-coupled Voltage Clamp” (dSVC) of restoring cells to a state in which they can provide in a delayed loop ion-channel conductance measurements for use in a neuronal simulation that includes these conductances. Further disclosed is constructing computational models of these conductances through a machine-learning algorithm trained and validated with real electrophysiological data. Also disclosed is a system that learns these models by first gathering data from real cells under novel real-world (e.g., in the presence of drugs) conditions, uses these data to train the system, then predicts channel states in models of neurons. Simulations of these models may then be used to test the effects of novel compounds on neural phenomena.

In one example, a system, a computer program product, and a method for constructions of models of ion-channel currents is described. The method begins by using a voltage clamp in electrical contact with a biological cell to record a time sequence of ion-channel currents in the biological cell. In one example, a dynamic action potential clamp (dAPC) is used. A recorded voltage history duration is selected that is sufficient for determining a command voltage in a voltage clamp that replicates ion-channel currents which have been recorded. A minimum history duration is determined that is required to satisfy a criterion difference over all subsequent recorded currents during a replaying of the history by i) replaying an associated voltage history of the recorded ion-channel currents over time-intervals as command voltages in a voltage clamp in electrical contact with the biological cell and measuring a present ion-channel current in the biological cell; ii) comparing the present ion-channel current to the ion-channel currents which have been recorded; and iii) determining when a specific recorded and the present ion-channel current fall within the criterion difference and recording an associated history duration. Subsequent model ion-channel currents are determined by replaying associated voltage histories of minimum required durations in a voltage clamp in electrical contact with the biological cell and recording the present ion-channel current.

In other examples, after the subsequent model ion-channel currents are determined, ion-channel currents are constructed to simulate membrane biophysics of a multitude of compartments in a neural simulation. The voltage histories from each compartment are used in the neural simulation as inputs to the voltage clamp to produce ion-channel currents simulated in each model compartment. Optionally, a multi-layer perceptron is applied to construct a model of the ion-channel currents to simulate membrane biophysics of a multitude of compartments in a neural simulation by i) using voltage histories from each compartment as inputs to the voltage clamp to produce ion-channel currents simulated in each model compartment; ii) collecting voltage histories generated by some set of the compartments of a multi-compartment model and presenting them as inputs to a multi-layer perceptron; iii) using ion-channel currents produced by the voltage clamp as desired outputs of the model to train the multi-layer perceptron; and iv) validating that the constructed model produces ion-channel currents within some confidence level using ion-channel currents produced by the voltage clamp.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 illustrates a prior art dynamic clamp system for the measurement of waveforms of a biological cell;

FIG. 2 is a dynamic clamp system of FIG. 1 using dAPC and machine learning;

FIG. 3 is a history of the current from FIG. 2;

FIG. 4 a diagram of how the simulation is paused while the biological cell is queried;

FIG. 5 and FIG. 6 is a flow chart of a method to construct models of ion-channel currents using the apparatus in FIG. 2;

FIG. 7 is illustration of how number of points in history can be reduced; and

FIG. 8 is a block diagram illustrating a detailed view of an information processing system for carrying out the operation of FIG. 5.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Non-Limiting Definitions

As used herein, the terms “waveform” and “trace” includes any variation in the amplitude or frequency in an electrophysiological parameter, for example the trans-membrane voltage, over time at a biological cell. Such variations result from modulation of a number of ion-channel or receptor types at the cell. In one embodiment, the waveform is an action potential or synaptic event. In another embodiment, the waveform is an action potential.

As used herein, a “voltage clamp” technique allows an experimenter to “clamp” the cell potential at a chosen value. This makes it possible to measure how much ionic current crosses a cell's membrane at any given voltage. This is important because many of the ion channels in the membrane of a neuron are voltage-gated ion channels, which open only when the membrane voltage is within a certain range. Voltage clamp measurements of current are made possible by the near-simultaneous digital subtraction of transient capacitive and transmembrane currents that pass as the recording electrode and cell membrane are charged to alter the cell's potential. See generally (Kandel E R, Schwartz J H, Jessell T M, eds., 2000, Principles of Neural Science, 4th ed., New York: McGraw-Hill. pp. 152-153).

As used herein a “current clamp” technique records the membrane potential by injecting current into a cell through the recording electrode. Unlike in the voltage clamp mode, where the membrane potential is held at a level determined by the experimenter, in “current clamp” mode the membrane potential is free to vary, and the amplifier records whatever voltage the cell generates on its own or as a result of stimulation. This technique is used to study how a cell responds when electric current enters a cell. This is important for instance for understanding how neurons respond to neurotransmitters that act by opening membrane ion channels, which change a post-synaptic cells membrane potential. See generally ((Kandel E R, Schwartz J H, Jessell T M, eds., 2000, Principles of Neural Science, 4th ed., New York: McGraw-Hill, pp. 152-153).

As used herein a “multi-compartment model” is a type of mathematical model used for describing the way materials or energies are transmitted among the compartments of a system. Each compartment is assumed to be a homogenous entity within which the entities being modeled are equivalent. For instance, in a pharmacokinetic model, the compartments may represent different sections of a body within which the concentration of a drug is assumed to be uniformly equal. Hence a multi-compartment model is a lumped parameters model. See generally (Segev I, Fleshman J W, Burke R E, 1989, “Compartmental models of complex neurons,” In: Methods in Neuronal Modeling, Koch C and Segev I, eds., Cambridge: MIT Press, pp. 63-96).

As used herein “machine learning” is a scientific discipline concerned with the design and development of algorithms that take as input empirical data, such as that from sensors or databases, and yield patterns or predictions thought to be features of the underlying mechanism that generated the data. A learner can take advantage of examples or data to capture characteristics of interest of their unknown underlying probability distribution. Data can be seen as instances of the possible relations between observed variables. A major focus of machine learning research is the design of algorithms that recognize complex patterns and make intelligent decisions based on input data. One fundamental difficulty is that the set of all possible behaviors given all possible inputs is too large to be included in the set of observed examples or training data. Hence the learner must generalize from the given examples in order to produce a useful output in new cases. See generally (Mohri M, Rostamizadeh A, Talwalkar A, 2012, Foundations of Machine Learning, Cambridge: MIT).

As used herein “dynamic clamp” describes a method of measuring the trans-membrane potential (or voltage) of a real excitable cell in a patch-clamp recording, then using this voltage to compute a change in conductance in a computational model of an ion-channel in real time. Typically, the method involves current-clamping an active cell that is expressing a variety of ion channels. The transmembrane voltage recorded from this real cell constrains a computational model of a virtual conductance, such that at each time step the voltage recorded from the current-clamped cell is used to calculate the current associated with the virtual conductance in the model. This computed current is then used as the applied current in the current-clamped cell to close the loop. In this configuration the system will behave as if the real cell is expressing the simulated ion-channel in its membrane, and the kinetics of this cell will thereby be modified by this novel conductance, introduced in this manner. See generally online Prinz, A. “The Dynamic Clamp Comes of Age.” Trends in Neurosciences, Volume 27, Issue 4, April 2004. Pages 218-24. Web (http://neurotheory.columbia.edui˜larry/PrinzTINS04.pdf).

As used herein the “dynamic action potential clamp” (dACP) describes a method of measuring ion-channel (e.g. voltage-gated sodium channels, or VGSCs) conductances in cells and using these conductances in a computational model of an excitable cell, or a single compartment of a multi-compartment model of an excitable cell, in real time. Typically, the method involves voltage-clamping a transfected cell line that expresses a single ion-channel subtype i.e., a “TCL1”, e.g. human embryonic kidney cells, like those of the HEK293 cell line. Transmembrane currents recorded from this real cell constrain a computational model of a cell or compartment containing its own virtual conductances. At each time step the current recorded from the voltage-clamped cell is summed with the currents generated by the virtual conductances in the model, and this sum is then divided by a membrane capacitance value and integrated to calculate the new trans-membrane voltage. This new voltage is then applied as the command potential to the voltage-clamped cell to close the loop. In this configuration of the system the model of the cellular compartment will behave as if it includes a model of the real cell's expressed ion-channel conductance. Thus, the model might generate action potentials even if it does not include a model of the ion-channel that is expressed in the real cell, recapitulating membrane biophysics that include the channel kinetics of the ion-channel that is expressed in the real cell.

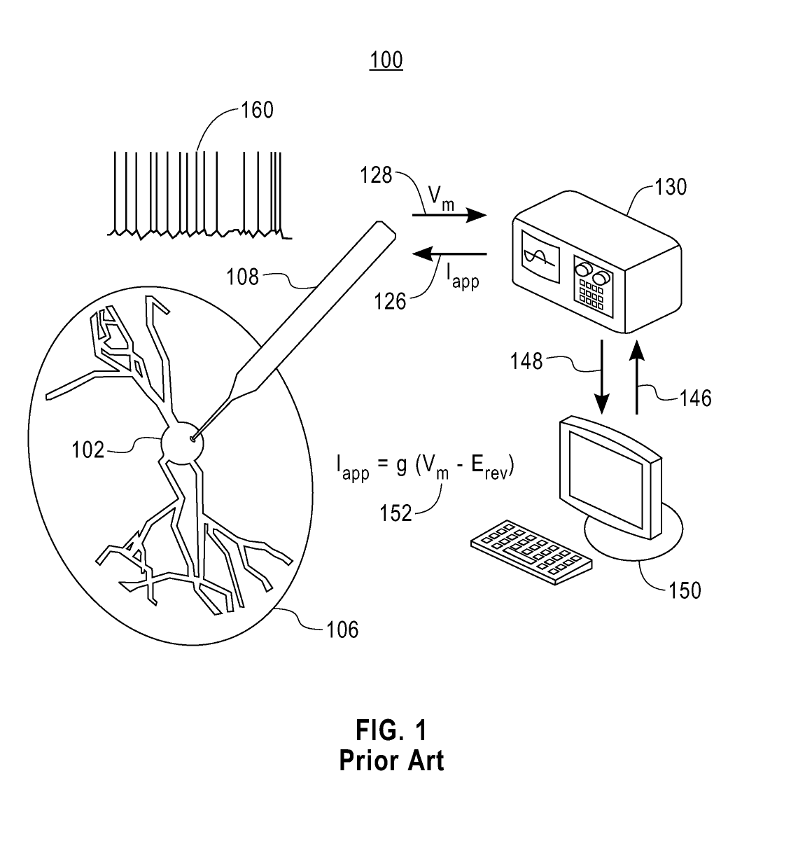

Turning now to FIG. 1, shown is prior art dynamic clamp system 100 for the measurement of waveforms of a biological cell 102 in a solution 106. A waveform at a biological cell (or part thereof) is generally produced by virtue of a functional inter-relationship between a number of different types of ion channels or receptors. Modulation of one, or a group of ion channels or receptors, results in electrophysiological changes at the membrane of the cell, causing further ion channels to be modulated, resulting in a waveform. Ion channels including, for example, sodium channels, potassium channels, calcium channels, chloride channels and hyperpolarisation-activated channels may be involved. In one example, a dynamic clamp 100 is provided in electrical contact with a biological cell 102. In assaying an ion-channel for its ability to modulate a biological cell, the dynamic clamp assists in providing a current waveform at a biological cell (or part thereof). Many types of dynamic clamp may be used. The dynamic clamp 100 may include, but is not limited to, one or more electrodes 108 which are electrically coupled to an amplifier/simulator 130, in control 146/148 by computer 150 and computational software coupled to an amplifier/simulator 130. The computer 150 and amplifier/simulator 130 forces an applied current I_{APP} generated by a simulation of an ion-channel model and measures a biological cell membrane voltage V_{M} as shown by the action potential waveform 160. Equations 152 is I_{APP}=g (V_{M}−E_{REV}), where E_{REV} is reverse potential of the modeled ion-channel 102 and g the voltage dependent conductance of the modeled ion-channel 102. See generally online Prinz, A. “The Dynamic Clamp Comes of Age.” Trends in Neurosciences, Volume 27, Issue 4, April 2004. Pages 218-24. Web. (http://neurotheory.columbia.edu/˜larry/PrinzTINS04.pdf).

### Using the Closed-Loop Techniques to Study Drugs

Advantageously, in the present application it is only necessary for one of the ion channels or receptor types to be present in the biological cell or part thereof. The function of the remaining ion channels or receptor types which are required to provide a waveform may be simulated using a dynamic clamp, which is configured to provide a real time feedback loop with the ion channels or receptor types that are present. To achieve this, the dynamic clamp can apply a voltage signal to the cell or part thereof. The signal is used to represent the electrophysiological changes to the cell that would be induced by the remaining ion channels. This allows the effects of a compound at only one type of ion-channel or receptor to be detected, while also observing the effect of the compound on the voltage waveform of a more complex system.

Pharmacological studies work toward identifying compounds which can act on ion channels to prevent pathogenic behavior in the channels, neurons that express them and neural circuits that comprise the neurons. Traditional methods for exploring the effects of different compounds on channel kinetics involve arduous and complex voltage-clamp experiments that offer limited insight into the effect of the compounds on real physiological behavior. Typically, compounds are applied to a cell which has been patch clamped in whole cell voltage-clamp mode and different voltage protocols are used to identify precisely how the drug modulates channel kinetics. In order to then translate these changes in channel behavior into changes in cellular firing patterns and circuit function, the data extracted from voltage-clamp experiments is used to characterize the channel kinetics with a set of parameters. These parameters are then used to build a mathematical model of a membrane conductance which is then incorporated into a computational model of a cell to simulate the effect of the modified channel behavior on cellular biophysics. The dAPC offers an alternative method, which eliminates the need for a computational model of the channel, and screens candidate compounds in real time by exposing, for example, TCL1 cells expressing the ion-channel to the compound of interest while in the dAPC configuration. The changes in channel behavior that arise from interaction with the compound then directly impact the behavior of the model cell and changes in firing patterns or general biophysics become immediately apparent, thus eliminating the need for arduously parameterizing models of the channel and its modulation by compounds.

Single Compartment, Real-Time Constraints of dAPC

Despite the promise of the dAPC technique in screening compounds for their impact on the complex kinetics of neurons expressing a multitude of channels, certain types of models remain inaccessible to the technique. For example, to recapitulate in vivo behavior the channel must interact with the model as it would with a real cell, with channel state transitions constantly informed by the state of the model. Typically this is achieved through ‘real time’ interaction between the model and the ion channels in the TCL1 cell, but if time steps are too long, the channel will change states between model inputs creating a non-physiological lag in communication. As model complexity increases, more equations must be solved to determine the model state at each time step, subsequently the time required to solve the equations between time steps increases. This will require additional computational power to maintain the real-time relationship of the model with the real-cell recording in the dAPC setup. Even for single compartment models, complexity may surpass the ability of the computational system to keep up with the real-time requirement of dAPC.

Second, to model the interaction of a novel ion-channel with a multi-compartment model of a neuron requires still more complexity, and introduces a challenge for dAPC, since each TCL1 cell in the apparatus described can only provide ion-channel conductance measures for a single modeled compartment. To apply dAPC to modeling multi-compartment neuronal models requires then a contingent of TCL1 recordings equal in number to the array of compartments, which becomes infeasible for realistic numbers of compartments (˜500-1000). Because multi-compartment neuronal models are required to capture the influence of cellular morphology and the differential distributions of ion channels on the integration properties of a neuron, the goal of studying drug interactions with a realistically modeled neuron requires overcoming the limitation.

Finally, to model the interaction of a novel ion-channel with a multi-neuron model of a neural tissue further magnifies the problem of the single compartment, real-time constraint of dAPC, since neural tissue simulations typically comprise thousands to millions of neurons and millions to billions of compartments.

Non-Real-Time, Delayed Simulation-Coupled Voltage Clamp (dSVC)

The inventive method disclosed here overcomes this issue by allowing the real cell's channel state to change arbitrarily between the time it is recorded for use in the calculation of a single compartment model's membrane potential and the time it is used again to record the next channel state for use in calculating the next membrane potential for the same compartment model. This arbitrary change is accommodated in dSVC, unlike in traditional dAPC, by restoring each real cell's channel to its state at the last time step. Restoration is achieved by exposing the real cell to the most recent voltage history before applying the command voltage for the next time step.

dSVC thus eliminates the requirement for real time functioning as it enables channels to be induced into a desired state with the appropriate history. Maintaining control over channel state and history makes it possible to use a single TCL1 cell to determine the conductance state of ion channels in multiple compartments. With the voltage history known for each compartment, a single TCL1 cell can be successively exposed to each compartment's history to then determine the next current value to be fed into each compartment model, and then all models solved simultaneously to calculate their next membrane potentials. The single TCL1 cell is effectively reset multiple times per simulation time step, so that it might be recorded multiple times as it generates currents in response to different conditions experienced by the different compartments. This allows for a departure from “real time” so the system can be used to construct larger network models which might include other neural tissue elements such as synaptic and electrical coupling between neurons.

Machine Learning Ion-Channel Models with dSVC

dSVC can be used in a novel manner i.e. to break the real-time constraints. By doing so a single HEK cell can be interrogated for the current that the ion-channel will produce for multiple compartments in a simulation. Most neurons require hundreds or thousands of compartments in their model representation due to their complex morphology comprising soma, axons, dendrites and their numerous branch points. Thus, a neuron can rarely be modeled as an isopotential point. Instead, often hundreds or thousands of isopotential points are required to capture a neuron's dynamics in a multi-compartment model.

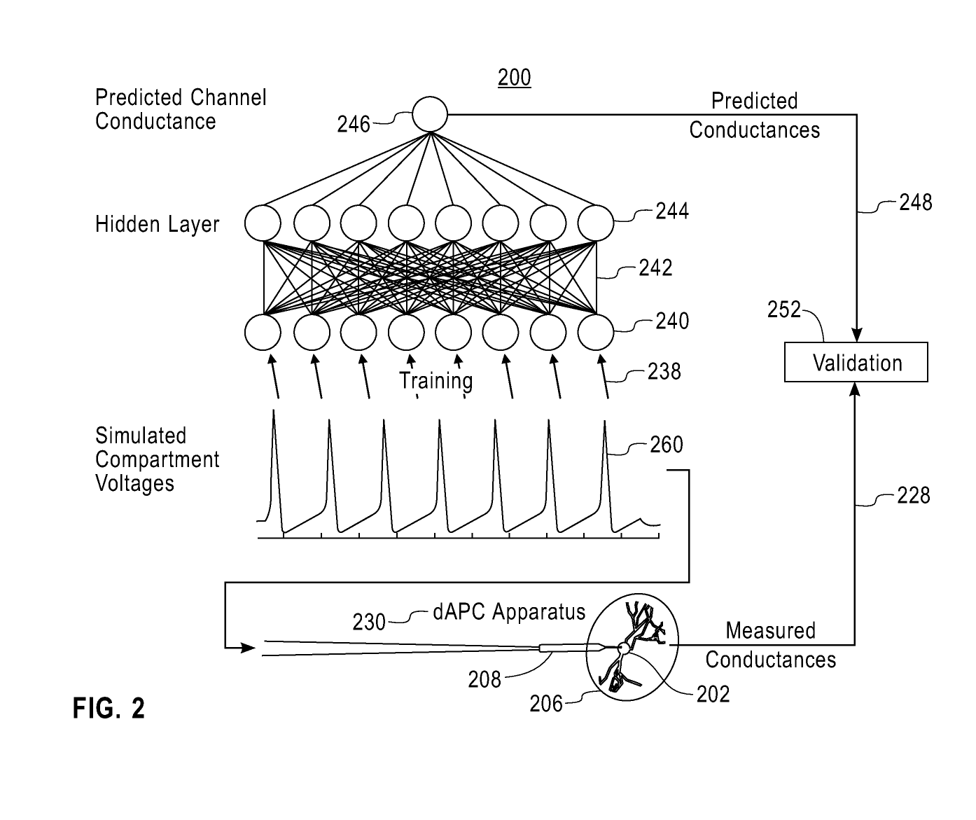

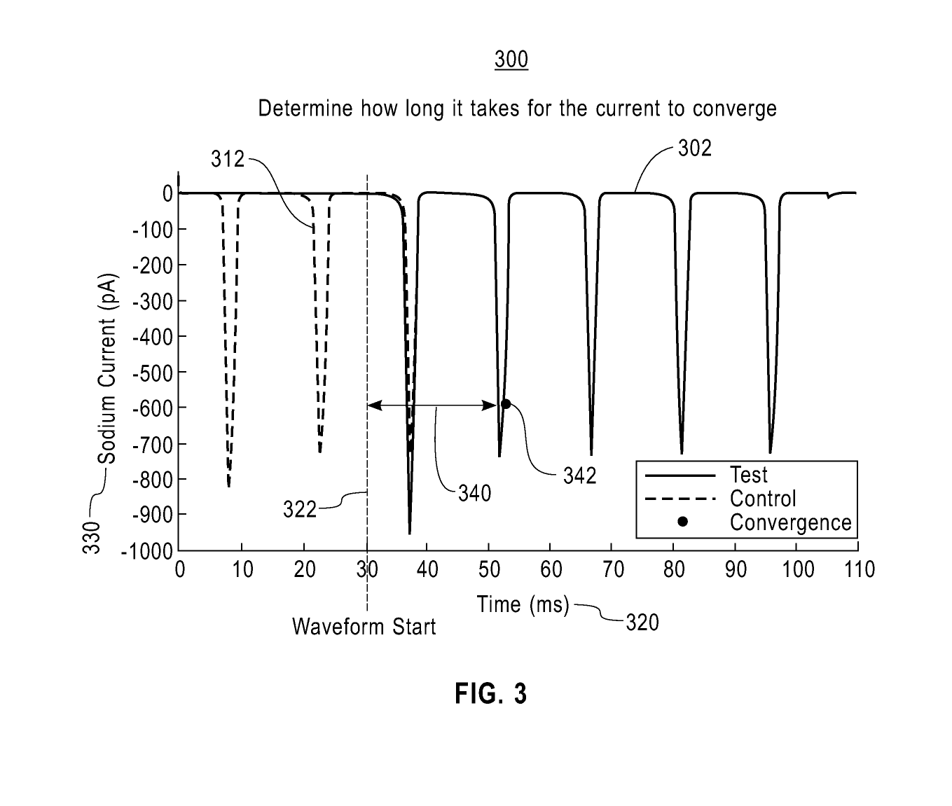

Turning to FIG. 2, shown is a dynamic clamp system of FIG. 1 using dAPC and machine learning 200. FIG. 3 is a history of the current from FIG. 2. dAPC apparatus 230 is connected to electrodes 208 coupled to biological cell 202 in solution 206. As further described below, a machine learning system 240, 242, 244 takes training inputs 260 from the dAPC apparatus. The measured conductances 228 are fed into validation logic 252 along with predicted conductances 248 from a predicted channel 246. (Note that the conductance of a channel or channels may be calculated in a voltage clamp experiment by dividing the measured current by the command voltage).

By departing from the real-time constraint, the claimed invention allows for simulating multi-compartment models of neurons in a neural tissue comprising a multitude of neurons, informed by a single voltage clamp patch recording of a cell expressing a channel. It also allows data collected (using the multiple voltage histories extracted from each compartment of a multi-compartment model) to become training data in machine-learning based models for predicting channel conductances, based solely on these voltage histories. In this way, the TCL1 cells may be at times replaced by trained neural networks, for example, in a preferred embodiment, a multi-layer perceptron, a radial basis function, or a kernel-based system, which predict channel conductances. After training, TCL1 cells may be periodically presented with voltage histories produced by compartments of a multi-compartment model, in order to validate that the neural network continues to make predictions that fall within a pre-determined confidence level for neural tissue simulations. Predictions made by the claimed invention's neural network are then used to provide channel conductances to the compartments of a multi-compartment model in the place of conductances recorded from a HEK293 cell expressing the ion-channel conductance, as in dAPC.

As shown in FIG. 3 history is important because the state of the channels at any given time is a consequence of the unique sequence of voltages it has experienced over its recent past. The dashed current trace 312 in FIG. 3 shows the sodium current generated by the channels when the waveform of a train of action potentials is applied to the HEK cell via a voltage-clamp. These action potentials were originally generated by a cell and at least two ion channels (i.e., sodium and potassium channels) that change conductance g based on voltage and time. The solid trace left of dotted line 322 shows the sodium current generated by the channels when the same waveform is applied to the HEK cell but beginning later in the waveform, i.e. 30 ms into the waveform. 342 shows the point when the current generated by the channels that experienced the full action potential train waveform, and the channels that only experienced the waveform from t=30 ms converge. This suggests that the channels require the length of time 340 worth of common history before they can be induced into the same state, i.e. the state the channels are in at 342.

Now applying this required history duration for inducing the measured channels into the current generating state they were in at a similar time point in a recorded voltage clamp, suppose a single HEK cell is used and we break the real-time constraint of dAPC. Assume two compartments—compartment 1 and compartment 2 start simulation with ion-channel currents as placeholders and step the simulation forward. With each time step, the accumulated history from compartment 1 and compartment 2 is played back. Furthermore, the length of history 340 that must be played back to get the HEK cell ion-channel in proper state to give a correct current is known. The history for compartment 1 is played back to, and the ion-channel current recorded from the HEK cell. Next, the history for compartment 2 is played back to, and the ion-current recorded from the same HEK cell. The recorded ion-currents are then used to step the simulation forward another time step. This provides a novel way to use the HEK cell to provide the correct current for an arbitrary number of compartments in this simulation. Obviously this simulation will not proceed as fast because the simulation must be paused while the HEK cell is interrogated for multiple compartments in order to determine the current on each time step for the channel expressed by the HEK cell. The single HEK cell is interrogated using multiple compartment histories in order to produce currents for multiple compartments. Thereby to understand how a drug will affect a large neuron and its physiology as opposed to a single isopotential compartment, a drug applied to the HEK cell will modulate the channel currents produced by the HEK cell for each compartment history of the multi-compartment simulation.

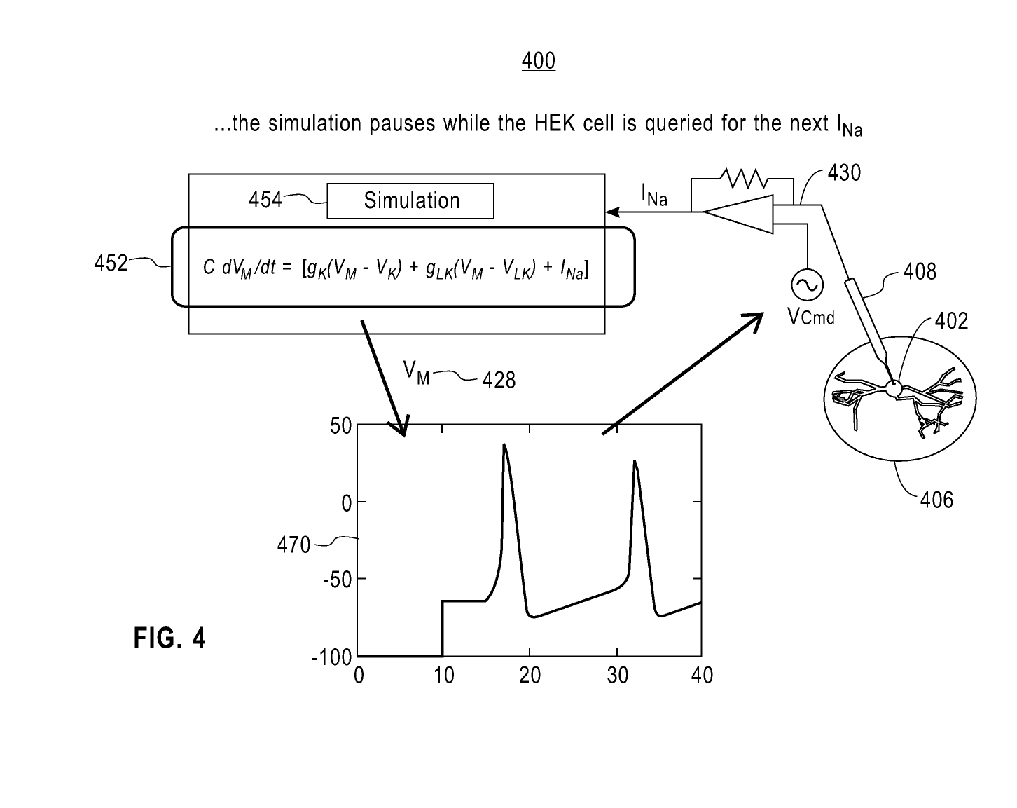

Turning now to FIG. 4, shown is a diagram 400 of how the simulation is paused while the biological cell 402 in solution 406 is queried in voltage-clamp mode (408, 430). The equation 452 uses the driving force on ions through different channel conductances to compute their respective transmembrane current contributions. Channels selectively pass certain ions. For example, the potassium (K) channel passes only potassium. This means that the driving force on potassium through this channel is the membrane potential (V_{M}) minus the reversal potential of potassium (V_{K}). The reversal potential of a channel is the membrane potential at which, given the concentrations both inside and outside the membrane of the ions, to which the channel is permeable, no ions will flow (calculated with a Nernst equation). If the concentrations are the same inside and outside the membrane, for example, the reversal potential equals zero.

Deviation from this reversal potential then drives ions through the channel, and in the case of potassium channels, the current is then g_{K}*(V_{M}−V_{K}), where g_{K} is the conductance of the potassium channel, which varies with voltage and time.

For the other channel types, a different subscript is used. V_{Lk} is the “leak” current, which is carried by several different ions (the leak conductance is assumed to not vary). V_{Na} is the sodium current, etc.

The command voltage V_{CMD} waveform is determined as above by the voltage history for the simulated compartment, here played back to the cell. The current measured after play back is the ion-channel current I_{Na}, and is fed back into the simulation. The simulation computes a time step but then pauses and waits for this next ion-current I_{NA}. The simulation then calculates V_{M} for the subsequent time step. The calculated membrane potential (V_{M}) is then added to the end of the history for play back, to measure the current for the simulation's next time step. After, the next step is computed and the procedure repeats until the simulation stops.

The waveform 300 of FIG. 3 shows how to experimentally determine a voltage history duration for playback to the ion-channel, for a given ion-channel undergoing dSVC. FIG. 4 is an artificially generated voltage history, computed based on dAPC and a simulated cell. The voltage history is not shown in FIG. 3, but may correspond in this invention to an artificially generated voltage as in FIG. 4. While this voltage is not generated in real-time, but rather a close loop simulation, it is played back to cells as in FIG. 3 in real time in order to determine next ion-channel currents.

Machine learning systems may take vectors 238, 752 and approximate a function.

Since the ion-channel is solely dependent on time and voltage this vector is sufficient in its representation of time and voltage to determine the ion-channel current. The equations that model ion channels are non-linear, and machine learning systems are good non-linear function approximators. The input vectors 238, 752 are the inputs to the machine learning system, and the predicted channel conductance 246 is the output of the machine learning system.

Using a neural network 240-246 training inputs 238 produces a value 246. The same training inputs 238 may be used for play back of history to a HEK cell as a V_{ow}. The correct I_{NA} is used to both calculate the next time step as the desired output to train the neural network. As the neural network converges 240-246 it will produce conductances that fall within an acceptable range when validated 252 against the conductances derived from the HEK cell.

This trained perceptron is then exploited to model drug interaction by exposing the TCL1 cell to compounds of interest when running the dAPC protocol to generate new training data. These new training data may modify or extend the perceptron accordingly, thus generating a new model of the channel kinetics under these drug conditions. This offers a novel method of building computational models without a detailed understanding of ion channels or their interactions with drugs and immediately incorporating these bootstrapped models and their predicted effects of these drug interactions on cellular biophysics into simulations of larger systems, including neural tissue simulations.

### Flow Chart

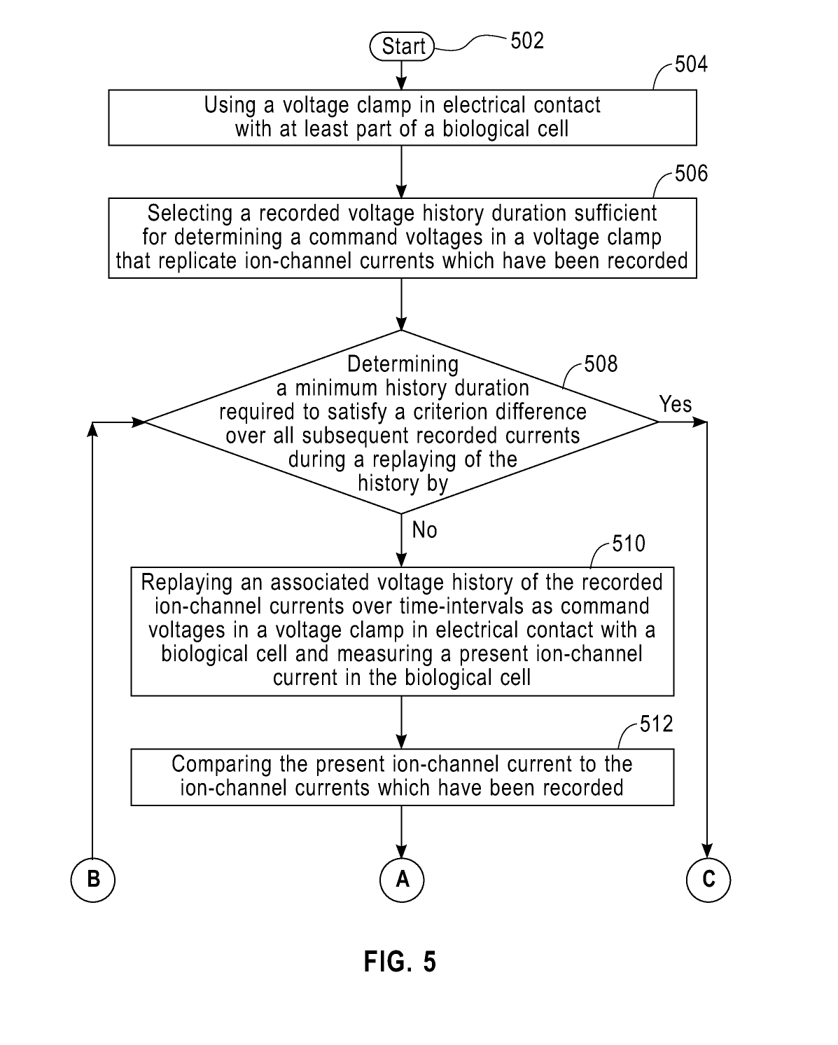

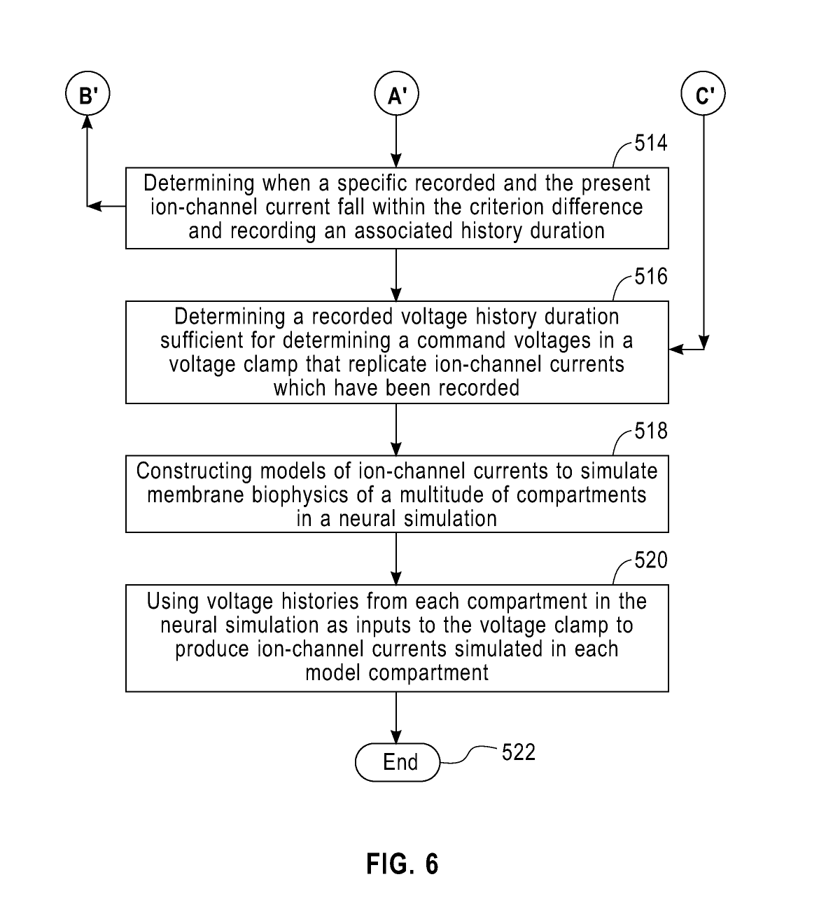

FIG. 5 and FIG. 6 is a flow chart of a method to construct models of ion-channel currents using the apparatus in FIG. 2.

The process begins at step 502 and immediately proceeds to step 504 in which a voltage clamp is in electrical contact with at least part of a biological cell 202. In one example, a dynamic action potential clamp (dAPC) is used. However the claimed invention is not limited to only a dAPC implementation. In step 506, a recorded voltage history duration is selected that is sufficient for determining a command voltages in a voltage clamp that replicate ion-channel currents which have been recorded. A loop is entered in step 508 in which a minimum history duration is determined that is required to satisfy a criterion difference over all subsequent recorded currents during a replaying of the history by i) step 510 replaying an associated voltage history of the recorded ion-channel currents over time-intervals as command voltages in a voltage clamp in electrical contact with a biological cell and measuring a present ion-channel current in the biological cell; ii) step 512 comparing the present ion-channel current to the ion-channel currents which have been recorded; and iii) step 514 determining when a specific recorded and the present ion-channel current fall within the criterion difference and recording an associated history duration. Once the minimum history is determined in step 508, the process continues to step 516 where a subsequent model ion-channel currents is determined by replaying associated voltage histories of minimum required durations in a voltage clamp in electrical contact with the biological cell, and recording the present ion-channel current. The process either ends in step 516 or optionally, ion-channel currents are constructed to simulate membrane biophysics of a multitude of compartments in a neural simulation in step 518. Next in in step 520 voltage histories are used from each compartment in the neural simulation as inputs to the voltage clamp, to produce ion-channel currents simulated in each model compartment and the process ends in step 522.

Aspects of the present application have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Resampling Voltage History

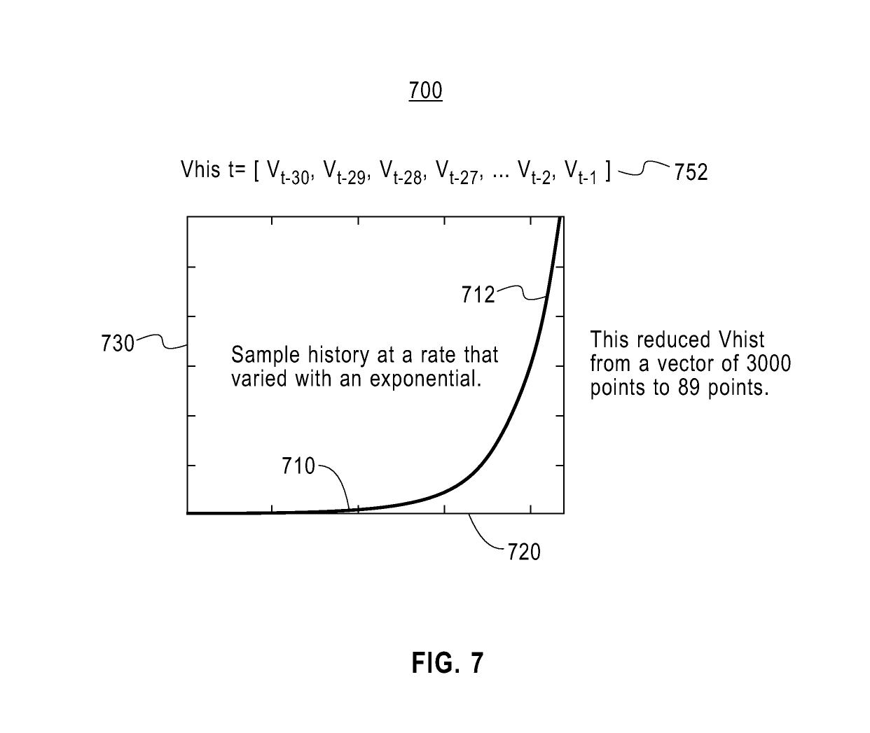

FIG. 7 is an illustration of how the number of points in the history vector can be reduced. A challenge is the input vector 752 of a neural network 240, 242, 244, grows larger as input vector gets larger. This is important for applications in which the computational resources are limited. Moreover, reducing the input vector reduces the risk of “over fitting” and increases the rate of learning. The input vector is made smaller by down sampling it in an unconventional way. Specifically, the input vector 752 is sampled at a high rate in recent history and the rate decreases for more distant history. This is shown in graph 700 in which the x-axis 720 is the index of samples of a history and the y-axis 730 is the sample rate at which each sample is taken. The decay constant K of curve 712 is set and varies the time points at which history is sampled. Playback (not shown) occurs at the same varying sample rates. The sample rates K are chosen to allow convergence.

Specifically, the replaying of the associated voltage history in step 510 of FIG. 5 can be further enhanced by determining a decay function for a sample rate for the associated voltage history. For example, a minimum sample rate (SRmin) for replaying the voltage history is chosen. Next a maximum sample rate (SRmax) for replaying the voltage history is chosen. In one example the maximum rate (SRmax) is the original sampling rate of the voltage history. The decay function from SRmax to SRmin separated in time by H is fitted. A number N of samples for history resampling such that a sum of all time intervals corresponding to N evenly spaced sample rates on the decay function equals H is chosen. The history over H N times is resampled using these time intervals, wherein high sample rates occur in a most recent history, and low sample rates in a most distant history of the time sequence which has been recorded. The history is replayed which has been resampled as command voltages in the voltage clamp in electrical contact with at least part of the biological cell. The present ion-channel current is compared to the ion-channel current that has been recorded. A specific recorded and previous current fall within a criterion difference and the associated resampling function is determined. Finally, a set of history resampling H′ is found that both minimizes N and satisfies the criterion difference over all recorded currents.

### Advantages

The present application includes many advantages. The following are a few features:
1. Computational models of ion-channel conductances can be constructed much more rapidly;
2. Models are generated by machine learning, reducing human intervention;
3. Models can be incorporated directly into multi-compartment simulations to create a closed-loop system for training, validation, and simulation; and
4. Effects of drugs or mutations on channel kinetics and multi-compartment neuron and neural tissue simulations can be modeled with ease.

### Operating Environment

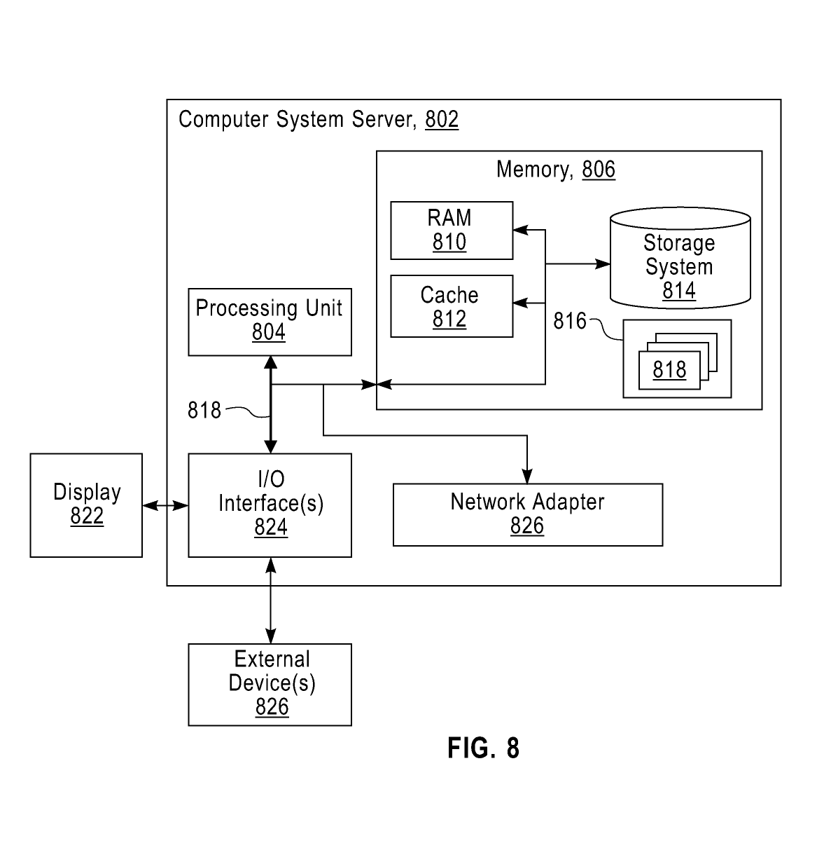

FIG. 8 is a block diagram illustrating a detailed view of an information processing system 802 for carrying out the operation of FIG. 5. Information processing system 802 is only one example of a suitable system and is not intended to limit the scope of use or functionality of embodiments of the present application described above. The exemplary information processing system 802 is capable of implementing and/or performing any of the functionality set forth above.

The information processing system 802 can be a networking node/element such as (but not limited to) the computer 150.

As illustrated in FIG. 8, the information processing system 802 is in the form of a general-purpose computing device. The components of the information processing system 802 can include, but are not limited to, one or more processors or processing units 804, a system memory 806, and a bus 808 that couples various system components including the system memory 806 to the processor 804.

The bus 808 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The information processing system 802 typically includes a variety of computer system readable media. Such media may be any available media that is accessible by the information processing system 802, and it includes both volatile and non-volatile media, removable and non-removable media.

The system memory 806, in one embodiment, comprises an order embedding algorithm and its components related to the flow chart in FIG. 5 and FIG. 6. These one or more components can also be implemented in hardware. The system memory 806 can include computer system readable media in the form of volatile memory, such as random access memory (RAM) 810 and/or cache memory 812. The information processing system 802 can further include other removable/non-removable, volatile/non-volatile computer system storage media. By way of example only, a storage system 814 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 808 by one or more data media interfaces. The memory 806 can include at least one program product having a set of program modules that are configured to carry out the functions of an embodiment of the present application.

Program/utility 816, having a set of program modules 818, may be stored in memory 806 by way of example, and not limitation, as well as an operating system, one or more application programs, other program modules, and program data. Each of the operating system, one or more application programs, other program modules, and program data or some combination thereof, may include an implementation of a networking environment. Program modules 818 generally carry out the functions and/or methodologies of embodiments of the present application.

The information processing system 802 can also communicate with one or more external devices 820 such as a keyboard, a pointing device, a display 822, etc.; one or more devices that enable a user to interact with the information processing system 802; and/or any devices (e.g., network card, modem, etc.) that enable the information processing system 802 to communicate with one or more other computing devices. Such communication can occur via I/O interfaces 824. Still yet, the information processing system 802 can communicate with one or more networks such as a local area network (LAN), a general wide area network (WAN), and/or a public network (e.g., the Internet) via network adapter 826. As depicted, the network adapter 826 communicates with the other components of information processing system 802 via the bus 808. Other hardware and/or software components can also be used in conjunction with the information processing system 802. Examples include, but are not limited to: microcode, device drivers, redundant processing units, external disk drive arrays, RAID systems, tape drives, and data archival storage systems.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Any combination of one or more computer readable medium(s) may be utilized. The computer readable medium may be a computer readable medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present application may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for constructions of models of ion-channel currents, the method comprising:
using a voltage clamp in electrical contact with at least part of a biological cell to record a time sequence of ion-channel currents in the biological cell;
selecting a recorded voltage history duration sufficient for determining a command voltages in a voltage clamp that replicate ion-channel currents which have been recorded;
determining a minimum history duration required to satisfy a criterion difference over all subsequent recorded currents during a replaying of the history by
replaying an associated voltage history of the recorded ion-channel currents over time-intervals as command voltages in a voltage clamp in electrical contact with the biological cell and measuring a present ion-channel current in the biological cell;
comparing the present ion-channel current to the ion-channel currents which have been recorded; and
determining when a specific recorded and the present ion-channel current fall within the criterion difference and recording an associated history duration; and
determining a subsequent model ion-channel currents by replaying associated voltage histories of minimum required durations in a voltage clamp in electrical contact with the biological cell and recording the present ion-channel current.

2. The method of claim 1, wherein the using a voltage clamp in electrical contact with at least part of the biological cell to record a time sequence of ion-channel currents in the biological cell and their associate voltage history includes using a dynamic action potential clamp (dAPC).

3. The method of claim 1, further comprising:
constructing models of ion-channel currents to simulate membrane biophysics of a multitude of compartments in a neural simulation; and
using voltage histories from each compartment in the neural simulation as inputs to the voltage clamp to produce ion-channel currents simulated in each model compartment.

4. The method of claim 1, further comprising:
applying a multi-layer perceptron to construct a model of the ion-channel currents by using voltage histories as a command voltages to the voltage clamp to produce ion-channel currents;
using ion-channel currents produced by the voltage clamp as desired outputs of the model to train the multi-layer perceptron; and
validating that the constructed model produces ion-channel currents within some confidence level using ion-channel currents produced by the voltage clamp.

5. The method of claim 4, further comprising:
applying a multi-layer perceptron to construct a model of the ion-channel currents to simulate membrane biophysics of a multitude of compartments in a neural simulation by using voltage histories from each compartment as command voltages; and
collecting voltage histories generated by some set of the compartments of a multi-compartment model and presenting them as inputs to a multi-layer perceptron.

6. The method of claim 4, further comprising:
retraining the multi-layer perceptron to meet this confidence level for a given neural simulation.

7. The method of claim 1, wherein the replaying the associated voltage history further comprises:
determining a decay function for a sample rate for the associated voltage history.

8. The method of claim 7, further comprising:
choosing a minimum sample rate (SRmin) for replaying the voltage history;
choosing a maximum sample rate (SRmax) for replaying the voltage history;
fitting the decay function from SRmax to SRmin separated in time by H;
choosing a number N of samples for history resampling such that a sum of all time intervals corresponding to N evenly spaced sample rates on the decay function equals H;
resampling the history over H N times using these time intervals, wherein high sample rates occur in a most recent history, and low sample rates in a most distant history of the time sequence which has been recorded;
replaying the history which has been resampled as command voltages in the voltage clamp in electrical contact with at least part of the biological cell;
comparing the present ion-channel current to the ion-channel current that has been recorded;
determining when a specific recorded and previous current fall within a criterion difference and noting the associated resampling function; and
finding a set of history resampling H′ that both minimizes N and satisfies the criterion difference over all recorded currents.

9. The method of claim 4, further comprising:
using a set of history resampling histories H′ to train a multi-layer perceptron where an input vector to the perceptron comprises N elements, where each element is a sample of a voltage history over duration H, and an output of the perceptron predicts a current.

10. The method of claim 4, further comprising:
determining when a multi-layer perceptron is appropriately trained using standard validation methods for multi-layer perceptron training, to some criterion level of predictions of the ion-channel currents compared to recorded currents from real cells expressing the modeled channel.

11. The method of claim 4, further comprising:
applying the multi-layer perceptron to construct a model of the ion-channel currents to simulate membrane biophysics of a multitude of compartments in a neural tissue simulation; and
using voltage histories from at least one compartment as inputs to the multi-layer perceptron, and the multi-layer perceptron produces outputs as one of gating variables, conductances, and currents of an ion channels simulated in each model compartment.

12. The method of claim 11, further comprising:
collecting voltage histories generated by some set of the compartments of a multi-compartment model and present them in voltage clamp to a real cell expressing the modeled channel; and
validating that the constructed model produces ion-channel currents within some confidence level using the recorded currents.

13-20. (canceled)
